(19) United States
(12) Patent Application Publication
(10) Pub. No.: US 2010/0251728 A1
(43) Pub. Date: Oct. 7, 2010

(54) Transportable electric generator plant fired by unprocessed coal being burned underground and producing non-vented gases

(76) Inventor: Larry F. Uselton, Shawneetown, IL (US)

Correspondence Address: Larry Francis Uselton, 245 West Meadowbrook Drive, Shawneetown, IL, 62984-3002, US

(21) Appl. No.: 12/384,559

(22) Filed: Apr. 6, 2009

(51) Int. Cl. F02C 3/28

(52) U.S. Cl. 60/780; 60/772

(57) ABSTRACT

With the double benefits of both coal gasification creating a usable synthetic fuel and of capturing and using the heat from the burning coal, too, does cut back drastically on the need of manpower to process raw coal. By replacing the greenhouse gases with burnt coal is a blessing for the environment. The transportable generator eliminates the need for any gases being added to the atmosphere. The costs of producing electricity will be reduced by about 78%. The gasification process is part of previous patent applications. However, this application uses both the gasification process combined with the heat transfer and transportable generator systems.

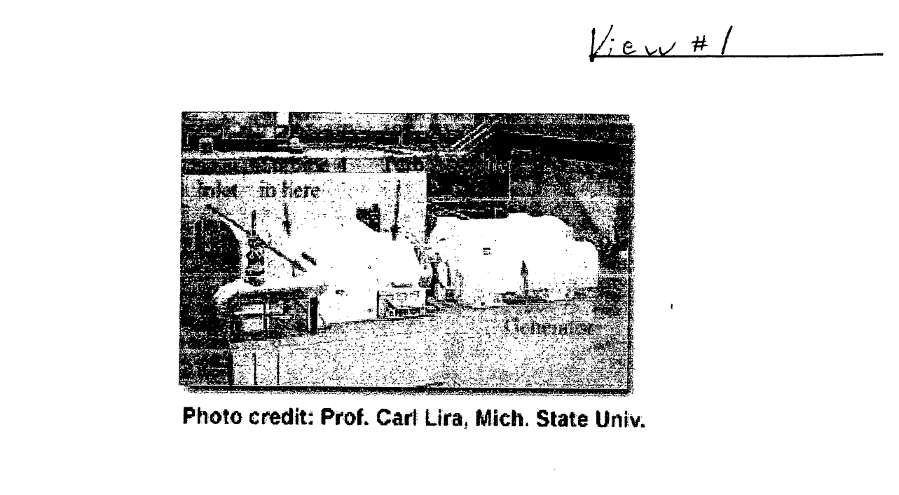

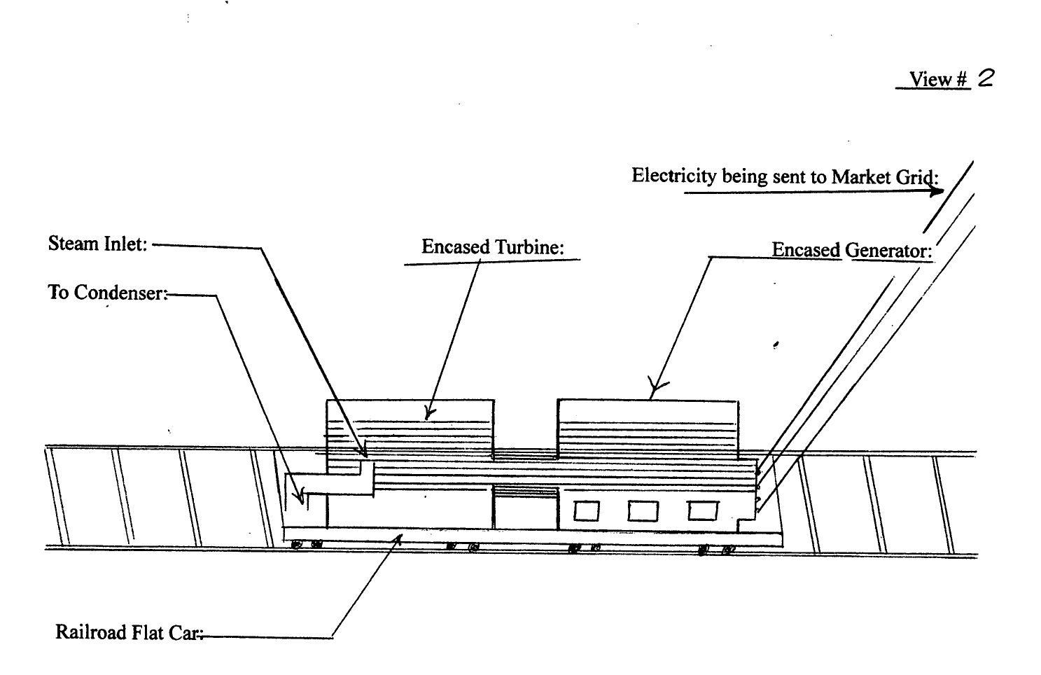

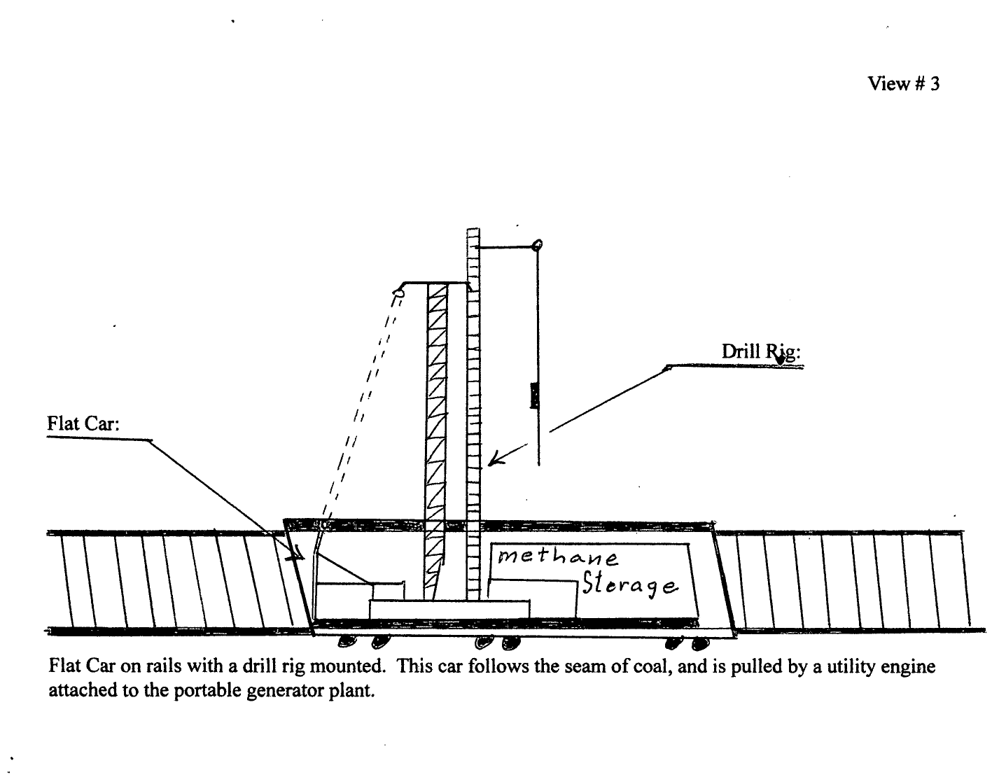

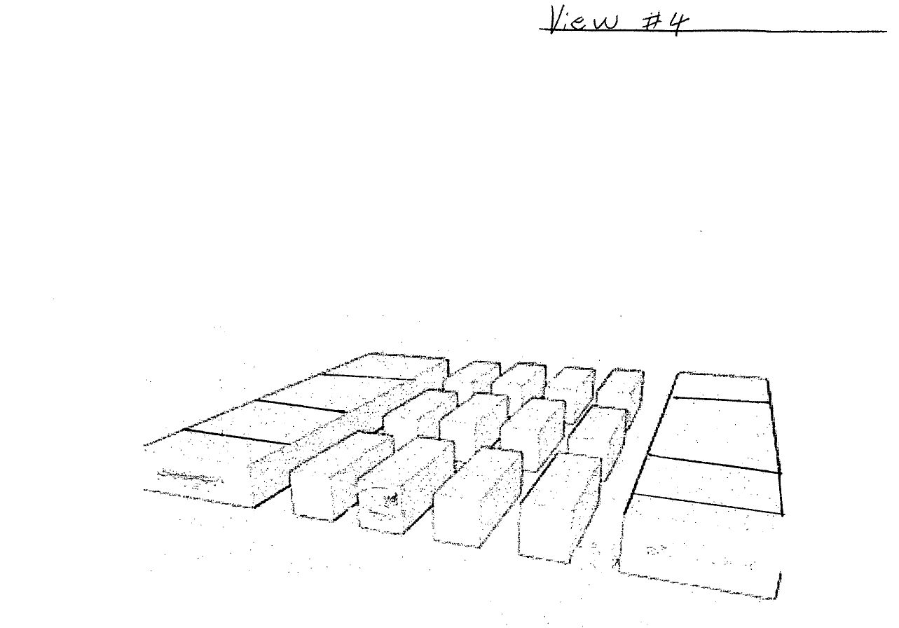

### CROSS-REFERENCE TO RELATED APPLICATION

There are no related applications on file by this applicant that refers to this application.

### STATEMENT REGARDING FEDERALLY SPONSORED RESEARCH OR DEVELOPMENT

There is no Federal Sponsored research in reference to this patent application.

### REFERENCE TO SEQUENCE LISTINGS, A TABLE, OR A COMPUTER PROGRAM LISTING COMPACT DISC APPENDIX

No sequence listing exists at this time.

### BACKGROUND OF THE INVENTION

The idea for this invention came to the applicant after studying the processing that coal had to go through before it was burned at a generating plant and also the thought of recovering methane at the same time. This invention will eliminate about 85% of the process involved in coal production and processing. Approximately 90% of the manpower previously required will be eliminated using this method.

### BRIEF SUMMARY OF INVENTION

This process utilizes the burning of coal while still underground and unprocessed to create methane and heat water there-by creating steam to power generator plant that an be fixed, transportable or at a mine-face. The plant could there-by be fueled by the steam or methane.

### BRIEF DESCRIPTION OF THE VIEWS OF THE DRAWINGS

Please see attachments of different views of drawings.

View I. View 1 has been deleted from the application

View II. View II is a drawing showing a flat car on rails carrying a transportable generator plant which includes a turbine, generator, and transformer. The generator is ran by either the steam or the methane being produced in this procedure

View III. View III is a drawing showing a drill rig on a rail road flat car. The rig is used to drill bore holes for lighting and controlling the coal seam fires. The fire is put out by cutting the oxygen supply to the fire. The holes also are used to collect the methane from the burning Coal. The drill rig is an old invention, but by it being placed on a flat car and added to the generator plant, I have incorporated it into my new invention.

View IV. View IV has been deleted from this application.

### DESCRIPTION OF THE PREFERRED EMBODIMENT

This process was devised for the dual purpose of lowering production costs of mining coal and to cut the costs of producing electricity substantially to the retail market.

It is recommended that a stable, in-ground, multi-year supply of either Anthracite or Bituminous coal be secured before beginning project.

A continuous, workable level, all-weather road should be constructed to provide right-of-way for utility vehicles and as a base for laying a rail track running along the coal seam.

A continuous supply of water needs to be available, preferably from an underground source.

The track rails must be laid, with 1 (or more) sized appropriate flat cars. On the car(s) is mounted a turbine, generator, and transformer. A utility engine must be available to move the car(s) when needed.

Fire can only burn with the assistance of oxygen reaching the coal bed. The burning process takes place in undisturbed coal seams connected to the surface by small boreholes. The process is completely sealed from the surface by a geological strata above and an interruption of the oxygen supply will completely stop the process. This eliminates the possibility that any uncontrolled fire could arise in this process. This is a proven procedure that has been used many times through the underground coal gasification process. The difference in my process doubles the benefits of those in the gasification process, by not only producing the methane but also of producing the steam in the same process. The coal gasification process is a known fact and is not claimed by this applicant.

This paragraph has been deleted from the original patent application by the applicant.

Holes must be bored into the coal seam at a depth to within one foot of the bottom of the seam. Pipes rated at +1,000 degrees Fahrenheit (540 degrees Celsius) are then injected into the bores.

The coal seam is ignited and water is injected into the pipes and allowed to circulate until the desired temperature of 1,000 F degrees is reached. The ignited coal is fed with oxygen to control the amount of heat needed to produce the steam. (The original final paragraph has been deleted and replaced with): The emissions from the burning process are stored in the space previously occupied by the burned coal.

The size of pipe is not considered because of variables at different locations including depth, temperature, etc.

The resulting steam is turbine on the rail car and then pushed to the generator at 1800 pounds per square inch. The turbines then spin the generators at 3600 revolutions per minute to make alternating current electricity at 20,000 volts. (Or to designed preference) (The following sentence is added to original application.) Because of variables, these numbers are flexible.

Water is pumped through a condenser to cool and condense the steam coming out of the turbines. The process continues at this method.

The mathematical calculations used in paragraphs 20, 21, and 22 were used in comparison of what the TVA uses at their Kingston Fossil Plant near Knoxville, Tenn.

Paragraph 26 has been eliminated in this updated application. After leaving the generators, the electricity is sent over the grid by transmission lines.

The information in paragraph 27 is old information and is not part of this patent application.

1. claim 1 is for the process to be used with a transportable generating plant, or being used for a permanent generating plant, or a mine-face generator plant.

2. claim 2 is the process of boring the holes into the coal bed, igniting it and feeding it with oxygen to control the temperature to produce the steam and methane simultaneously.

3. claim 3 is the process of eliminating the traditional method of extracting the coal, but to burn it underground to create the steam and methane and to use either or both to power the generator.

4. (canceled)

5. (canceled)
